(19) United States
(12) Patent Application Publication
(10) Pub. No.: US 2004/0257232 A1
(43) Pub. Date: Dec. 23, 2004

(54) Retractable coil unit for tags

(76) Inventor: Glen Walter Garner, Toronto (CA)

Correspondence Address: DOWELL & DOWELL PC, 2111 Eisenhower Ave., Suite 406, Alexandria, VA, 22314, US

(21) Appl. No.: 10/834,389

(22) Filed: Apr. 29, 2004

Related U.S. Application Data
(60) Provisional application No. 60/467,160, filed on May 2, 2003.

(51) Int. Cl. G08B 13/14

(52) U.S. Cl. 340/572.8

(57) ABSTRACT

A retractable coil unit is for use in association with a tag. The retractable coil unit and the tag in combination are used to hold a pair of items together. The retractable coil unit includes a coil unit, a retractable wire and a tag attachment device. The retractable wire has one end retractably housed in the coil unit and the other end having a wire attachment device. The tag attachment device is operably connected to the coil unit. The retractable coil is for use in association with tags that are generally either security tags or inventory control tags.

### CROSS REFERENCE TO RELATED PATENT APPLICATION

This patent application relates to U.S. Provisional Patent Application Ser. No. 60/467,160 filed on May 2, 2003 entitled RETRACTABLE COIL PIN FOR SECURITY TAGS which is incorporated herein by reference.

### FIELD OF THE INVENTION

This invention relates to tags and in particular tags that may be used as security tags or inventory control tags and that are designed to be used to hold pairs of items together.

### BACKGROUND OF THE INVENTION

Over the last few decades the face of retail sales has changed considerably. Specifically there has been an increase in the “big box” stores. In these stores the merchandise is generally available for the customer to see and in many instances it is available for the customer to try on. The challenge with these types of stores is to ensure that products that are sold in pairs remain together. This is particularly important with shoes so that shoes of the same size remain together. If shoes or other paired items fail to remain together there is a risk that the mismatched items will be sold together leaving the remaining item unsaleable. Further, valuable time is also wasted trying to match items that have previously been mismatched.

In some stores, currently items are secured together with a wire lanyard. The wire lanyard typically has a loop at each end thereof. One end is secured to each item of the pair. A wire lanyard may also be used to secure awkwardly shaped items such as hand bags or tennis rackets. Alternatively in some store shoes have a security tag attached to each item and then the pair are tied together with a plastic tie. The problem with this arrangement is that not all shoes have a hole for a tag and pin to be attached. Further the plastic tie is fixed and accordingly it is difficult for the potential customer to try on the shoes.

In many retail stores, shoes today and likely in the future are available for open sale where the buyer can pick and choose the shoes they are interested in with no assistance from a sales assistant. The challenge is to provide an inventory device that ensures that the shoes remain together at all times, that allows the shoes to be spread apart so that the customer can try on at least one of the shoes and that allows the shoes to be returned to the shelf together should the customer decide not to purchase them. Secondly, preferably the device would also to be used as a security device to protect the items against illicit removal. Thirdly, preferably the device would work with current security technology or varying styles of security tags in use in the store.

Accordingly it would be advantageous to provide a device that would easily secure two items together. Further it would be advantageous to provide a device that would provide inventory control as well as security. As well it would be advantageous to provide a device that secures a plurality of items together and includes a security tag.

### SUMMARY OF THE INVENTION

The present invention provides a security device that can readily be implemented with a variety of security systems that are currently in use in retail establishments. Further, the present invention allows the shoes to be pulled apart so that the customer may more easily try them on but the shoes cannot be easily decoupled.

According to the present invention, a retractable coil unit for use in association with a tag is provided. The retractable coil unit includes a coil unit, a retractable wire and a tag attachment device. The retractable wire has one end retractably housed in the coil unit and the other end having a wire attachment device. The tag attachment device is operably connected to the coil unit.

The objective of the present invention is to provide a device that will secure more than one item together.

It is another object of the present invention to provide a device that provides inventory control as well as securing two items together.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a side view of a retractable coil unit constructed in accordance with the present invention shown with a security tag;

FIG. 2 is a perspective view of the retractable coil unit of FIG. 1 shown with a security tag and in use with a pair of shoes;

FIG. 3 is a side view of an alternate embodiment of the retractable coil unit of the present invention, shown with a security tag;

FIG. 4 is a side view of a second alternate embodiment of the retractable coil unit of the present invention including a ratchet lock;

FIG. 5 is a side view of a third alternate embodiment of the retractable coil unit of the present invention showing a pin at the end of the retractable coil;

FIG. 6 is a perspective view of the retractable coil unit of FIG. 5 shown with two security tags and in use with a pair of shoes; and

FIG. 7 is a side view of a fourth alternate embodiment of the retractable coil of the present invention including a magnetic pin.

### DETAILED DESCRIPTION OF THE INVENTION

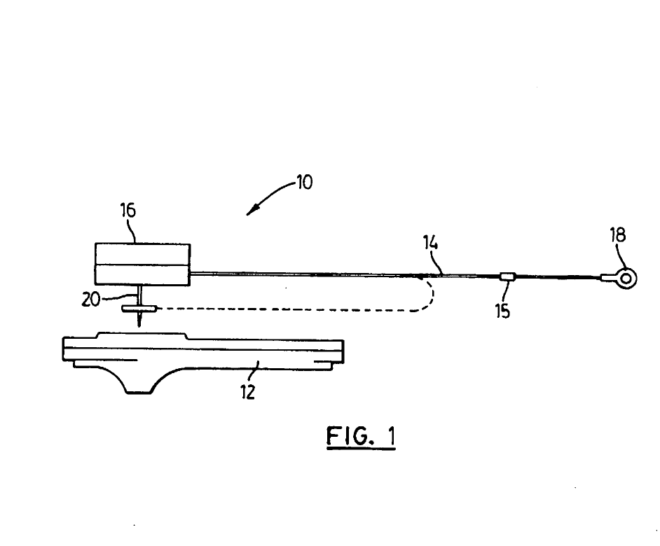

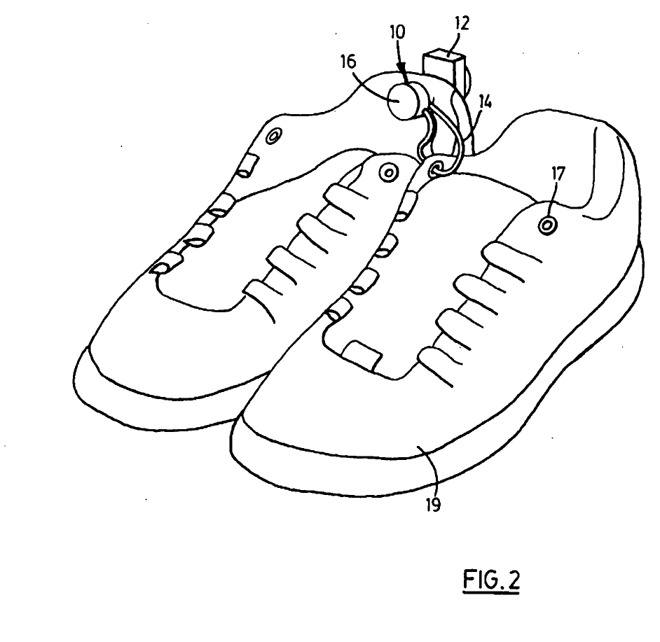

Referring to FIG. 1, the retractable coil unit of the present invention is shown generally at 10. The retractable coil unit 10 can be locked into the security tag 12. The retractable coil unit has a wire 14 which is extendable from a coil apparatus 16. As shown in FIG. 2, the wire 14 from the coil apparatus 16 can be threaded through a shoe eyelet 17 on a shoe 19. The wire 14 is provided with an eyelet 18 at the end thereof through which the pin 20 can fit. Preferably the wire 14 has a stop 15 attached thereto spaced from the eyelet 18. The stop 15 stops wire 14 from fully retracting thus making it easier for the user to attach the retractable coil unit to a pair of items. The retractable coil unit 10 includes a mechanism that allows the wire 14 to be pulled out of the coil apparatus 16. Preferably when pressure is released the wire retracts thus keeping the pair of items together. In use the eyelet 18 is threaded through a shoe eyelet 17 on one of the pair of shoes 19 and the security tag 12 and retractable coil 10 is attached to the other shoe thus attaching the pair of shoes. The shoes can be spread apart or retract when returned to display. As there are many shoe designs where there are no shoe eyelets the retractable coil unit may have a loop that thread through the roof chambers of the shoe and returns to the coil unit and the pin is placed through the loop and then into the tag, thereby securing the unit. Alternatively, the retractable coil unit 10 could also be used in conjunction with a conventional security tag and pin where the shoe does not include an eyelet. In use then, the conventional security pin would be positioned through the eyelet 18 of the retractable coil unit 10 and then through the shoe and the security tag would be secured to the conventional security pin. The retractable coil unit 10 would be secured to the other shoe of the pair of shoes.

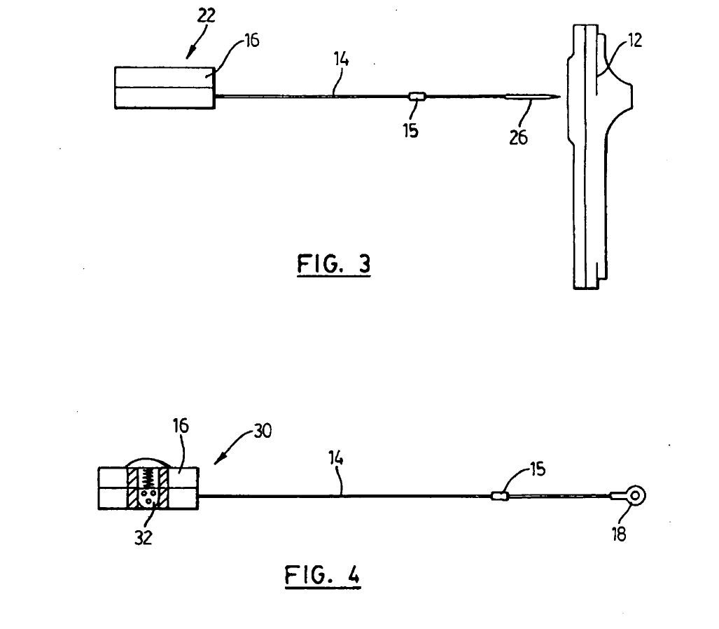

Referring to FIG. 3 an alternate embodiment of the retractable coil unit is shown generally at 22. The retractable coil unit 22 is a magnetic type unit that is attachable to a magnetic type security tag (not shown). The end of the wire 14 has a pin 26 that is insertable into a pin type security tag 12. As described above the retractable coil unit 22 includes a wire 14 that can be pulled out and then retracts.

The retractable coil unit of the present invention may have a number of variations. For example as shown in FIG. 4 the retractable coil unit 30 may include a ratcheting device 32 such that when the user pulls out the wire 14 it does not retract, the ratchet holds it in place. The wire may then tighten on a quick pull and release. Such a mechanism is similar to that found on a seat belt in a car or the cord with a vacuum cleaner. Alternatively the mechanism could be arranged such that the wire recoils responsive to a particular action by the store such as use of a key or releasing the security pin.

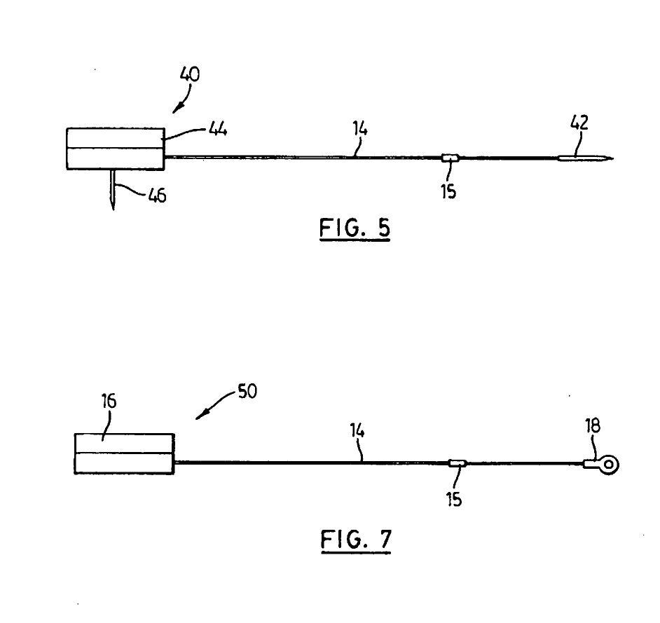

A third alternative retractable coil unit is shown generally at 40 in FIG. 5 wherein the wire 14 has a pin 42 on one end thereof and the retractable coil apparatus 44 includes a pin 46. This would be attached to the pair of items such as shoes 45 with two security tags as shown in FIG. 6. Alternatively it could be used with a security tag and a dummy tag. This type of retractable coil unit is particularly useful wherein the shoes 45 do not include an eyelet, thus the each end of the retractable coil unit 40 is attached to one of the pair of shoes 45 or other item to be attached together.

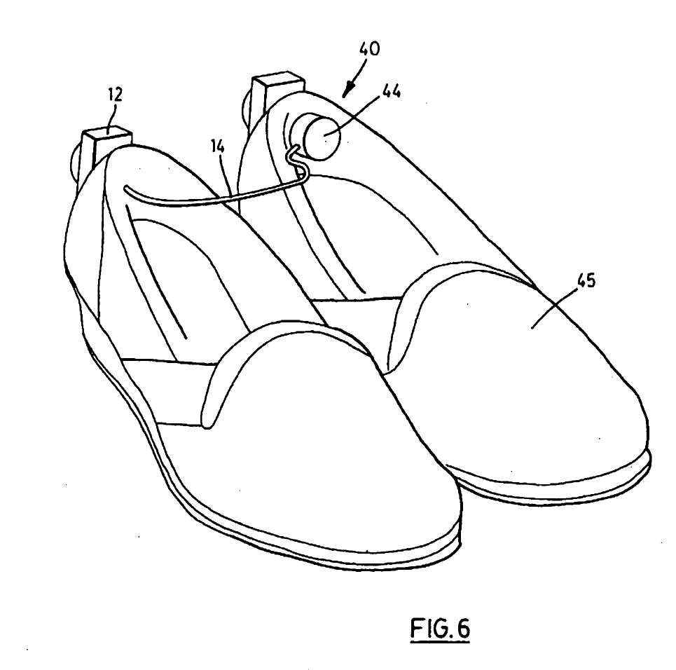

A fourth alternate retractable coil unit is shown generally at 50 in FIG. 7. Pin 50 includes a magnetic type pin and a eyelet 18 at the end of the wire 14.

The retractable coil unit of the present invention may also be adapted to include additional security features. For example the pin may include a mini circuit board with a small battery that will emit an audible alarm if the wire 14 is cut. Alternatively the retractable coil unit could include radio frequency identification technology wherein a signal is sent to a central location indicating that the wire 14 has been tampered with. Further it will be appreciated by those skilled in the art that the tag could be a dummy tag which does not include security features. In such a case the retractable coil unit of the present invention would be used primarily for the inventory control.

It will be appreciated by those skilled in the art that the user may determine the thickness of the wire and the strength of the recoil. Different thicknesses and strengths will be useful for different applications. In addition, different lengths of wire may be used for different applications. Further the tag may also include a release feature such that if a force over a predetermined amount is applied to the retractable coil unit, the wire will be released. Such a feature will reduce the likelihood of a customer tripping when trying on shoes.

As used herein, the terms “comprises” and “comprising” are to be construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

It will be appreciated that the above description related to the invention by way of example only. Many variations on the invention will be obvious to those skilled in the art and such obvious variations are within the scope of the invention as described herein whether or not expressly described.

What is claimed as the invention is:

1. A retractable coil unit for use in association with tags comprising:
a coil unit;
a retractable wire having one end retractably housed in the coil unit and the other end having a wire attachment means; and
a tag attachment means operably connected to the coil unit.

2. A retractable coil unit as claimed in claim 1 wherein the tag attachment means is a pin.

3. A retractable coil unit as claimed in claim 1 wherein the tag attachment means is a magnet.

4. A retractable coil unit as claimed in claim 2 wherein the wire attachment means is a pin.

5. A retractable coil unit as claimed in claim 2 wherein the wire attachment means is an eyelet.

6. A retractable coil unit as claimed in claim 3 wherein the wire attachment means is a pin.

7. A retractable coil unit as claimed in claim 3 wherein the wire attachment means is an eyelet.

8. A retractable coil unit as claimed in claim 1 wherein the coil unit includes a ratch type mechanism and the retractable coil is operablely attached to the ratch type mechanism.

9. A retractable coil unit as claimed in claim 8 wherein the ratch type mechanism is lockable.

10. A retractable coil unit as claimed in claim 1 wherein the tag is a security tag.

11. A retractable coil unit as claimed in claim 4 wherein the tag is a security tag.

12. A retractable coil unit as claimed in claim 5 wherein the tag is a security tag.

13. A retractable coil unit as claimed in claim 6 wherein the tag is a security tag.

14. A retractable coil unit as claimed in claim 7 wherein the tag is a security tag.

15. A retractable coil unit as claimed in claim 1 further including a stop attached to the retractable wire spaced from the other end thereof.

16. A retractable coil unit as claimed in claim 2 further including a stop attached to the retractable wire spaced from the other end thereof.

17. A retractable coil unit as claimed in claim 3 further including a stop attached to the retractable wire spaced from the other end thereof.
